(19) United States
(12) Patent Application Publication
(10) Pub. No.: US 2012/0015594 A1
(43) Pub. Date: Jan. 19, 2012

(54) DEMAND-BASED FRESH AIR CONTROL SYSTEM

(75) Inventors: Srinivasa R. Yenneti, Bangalore (IN); Lubos Forejt, Statenice (CZ); Radim Cermak, Prague (CZ)

(73) Assignee: THERMO KING CORPORATION, Minneapolis, MN (US)

(21) Appl. No.: 12/836,252

(22) Filed: Jul. 14, 2010

(51) Int. Cl. B60H 1/00; F25B 39/04; B60H 1/34

(52) U.S. Cl. 454/75; 454/155; 62/507

(57) ABSTRACT

A demand-based air conditioning system for a passenger vehicle that may utilize one or both of a contaminate sensor and a door sensor. A controller operates a damper to send an estimated amount of fresh air into a passenger compartment, based on the sensed level of contaminate in the passenger compartment, to ensure the air quality in the passenger compartment is acceptable for passengers.

### BACKGROUND

A supply of fresh (outdoor) air is required for transport vehicle passenger compartments. It is the purpose of this invention to provide a system and method for providing an appropriate amount of fresh air to a vehicle passenger compartment.

### SUMMARY

In one embodiment, the invention provides a passenger vehicle air conditioning system that includes a fresh air duct fluidly connecting ambient air of the environment outside of the passenger vehicle and a passenger compartment inside of the passenger vehicle. The passenger vehicle air conditioning system also includes a damper disposed in the fresh air duct and movable within the duct to vary the amount of ambient air allowed to enter the passenger compartment, a sensor operable to monitor a level of contaminate indicative of the contaminate level within the passenger compartment of the passenger vehicle, and a controller in communication with the contaminate sensor and the damper. The controller moves the damper to vary the amount of fresh air that enters the passenger compartment based on the level of contaminate sensed by the contaminate sensor.

In another embodiment, the invention provides a passenger vehicle having a passenger compartment and a fresh air duct fluidly connecting ambient air of the environment outside of the passenger vehicle and the passenger compartment inside of the passenger vehicle. The passenger vehicle also has a damper disposed in the fresh air duct and movable within the duct to vary the amount of ambient air allowed to enter the passenger compartment, a contaminate sensor operable to monitor a level of contaminate indicative of the contaminate level within the passenger compartment of the passenger vehicle, and a controller in communication with the contaminate sensor and the damper. The controller moves the damper to vary the amount of fresh air that enters the passenger compartment based on the level of contaminate sensed by the contaminate sensor.

One embodiment of the invention provides a method of operating an air conditioning system of a passenger vehicle. The method includes fluidly connecting, with a fresh air duct of the air conditioning system, ambient air of the environment outside of the passenger vehicle and a passenger compartment inside of the passenger vehicle. The method also includes providing a damper disposed in the fresh air duct, monitoring a level of contaminate within a passenger compartment of the passenger vehicle, and moving the damper to vary the amount of fresh air that enters the passenger compartment based on the level of contaminate.

Other aspects of the invention will become apparent by consideration of the detailed description and accompanying drawings.

### BRIEF DESCRIPTION OF THE DRAWINGS

FIG. 1 is a schematic view of one embodiment of the invention.

FIG. 2 is a schematic view of the air conditioning system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Passengers in a passenger vehicle 10 produce various air contaminates which can be particulate or gaseous in nature. In order to provide a safe and comfortable environment for the driver and passengers riding in a passenger vehicle 10, fresh (outdoor) air must be introduced to dilute the produced contaminates to a safe and acceptable level. The concentration level of the produced contaminants is proportional to the fresh (outdoor) air ventilation rate in a passenger vehicle where the air is mixed. The air in a passenger vehicle can be mixed by a fan, by the movement of people, or by the opening of doors or windows. At lower concentrations, carbon dioxide or other air contaminates can be used as a proxy for human produced odor.

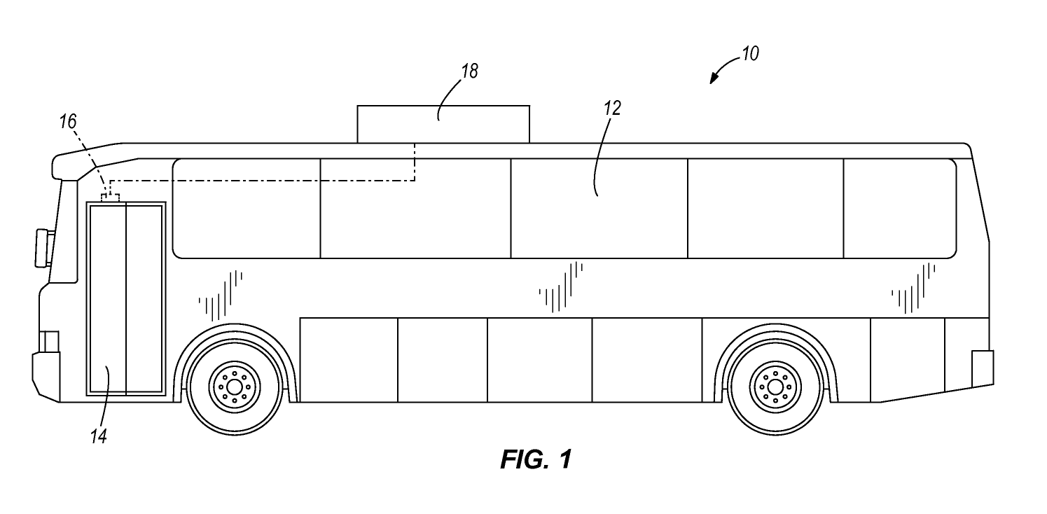

FIG. 1 is a schematic view of a passenger vehicle 10. The passenger vehicle 10 has a passenger compartment 12, a door 14, a door sensor 16, and an air conditioning system 18.

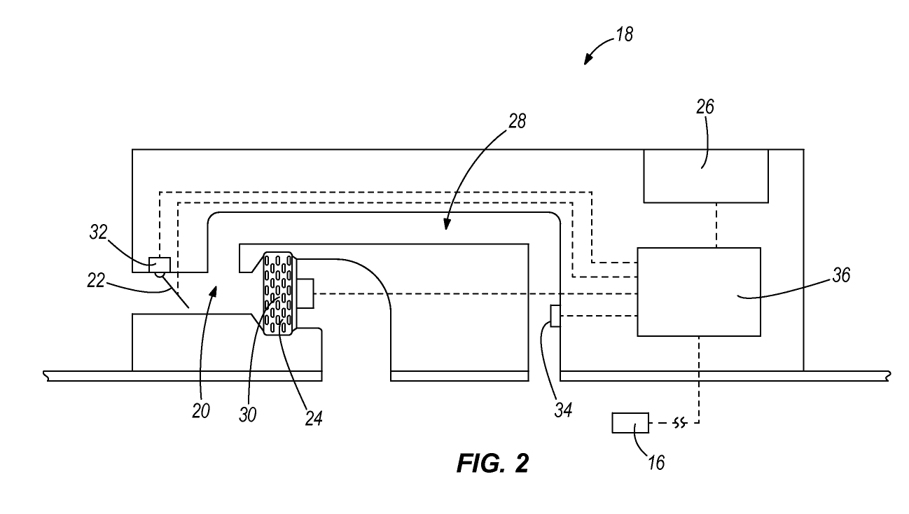

FIG. 2 is a schematic view of the air conditioning system 18 of FIG. 1. The air conditioning system 18 includes a fresh air duct 20 which fluidly connects ambient air of the environment outside of a passenger vehicle 10 and a passenger compartment 12 inside of the passenger vehicle 10. A damper 22 is disposed in the fresh air duct 20 and is operable to vary the amount of fresh air that passes through the fresh air duct 20. An evaporator 24 is disposed in the fresh air duct 20, the evaporator 24 being connected to a compressor 26. A return air duct 28 fluidly connects the passenger compartment 12 to the fresh air duct 20. An evaporator fan 30 is coupled to the evaporator 24 and serves to move fresh air from the fresh air duct 20 into the passenger compartment 12. In an alternative embodiment, the evaporator fan 30 is not coupled to the evaporator 24. The evaporator fan 30 also serves to move air from the passenger compartment 12 into the return air duct 28 and then into the fresh air duct 20. A damper sensor 32 monitors the position of the damper 22. A carbon dioxide sensor 34 is disposed in the return air duct 28 and is operable to monitor a level of carbon dioxide indicative of the level of carbon dioxide within the passenger compartment 12 of the vehicle. A controller 36 communicates with the door sensor 16, damper 22, damper sensor 32, evaporator 24, compressor 26, evaporator fan 30, and carbon dioxide sensor 34.

The controller 36 is operable to move the damper 22 and vary the speed of the compressor 26 and evaporator fan 30. The damper sensor 32 senses the status of the damper 22, including the percentage of full open, the occurrence of a damper opening event and the duration of the damper opening event. The door sensor 16 senses the occurrence of a door opening event, and also measures the duration of the door opening event. The controller 36 is operable to control the damper 22 and the evaporator fan 30 to vary the amount of fresh air that enters the passenger compartment 12 based on the level of carbon dioxide sensed by the carbon dioxide sensor 34. In an alternative embodiment the controller 36 varies the damper 22 and the evaporator fan speed based on the occupancy of the passenger compartment 12, which is predicted by at least one of the level of carbon dioxide sensed by the carbon dioxide sensor 34, the rate of change of the level of carbon dioxide sensed by the carbon dioxide sensor 34, and the amount of fresh (outdoor) air that is introduced into the passenger vehicle 10. Fresh air is introduced into the passenger vehicle 10 through the door 14 and/or the vehicle air conditioning system 18.

The controller 36 can be programmed with at least one of a preset carbon dioxide level that is based on the amount of carbon dioxide exhaled by a person (i.e. grams of carbon dioxide per minute per person), a required amount of fresh air per person, the interior volume of the passenger compartment 12, and how quickly fresh air can mix with the air in the passenger compartment 12. In another embodiment, the controller 36 can be programmed with a preset carbon dioxide level, where the preset carbon dioxide level is determined by an expressed comfort level of persons in the passenger compartment 12 of a passenger vehicle 10 in a test situation. That is, various levels of carbon dioxide are tested to determine passenger comfort for the tested level of carbon dioxide. The level of carbon dioxide in ambient air outside of the vehicle 10 is well known and substantially stable.

The embodiment illustrated in FIG. 1 functions as follows. The carbon dioxide sensor 34 monitors the level of carbon dioxide in the passenger compartment 12 and communicates the level of carbon dioxide to the controller 36. The controller 36 receives the monitored carbon dioxide level and compares it to the preset carbon dioxide level. In some embodiments the preset carbon dioxide level is a range of carbon dioxide levels. If the monitored level of carbon dioxide is above the preset level of carbon dioxide, then the controller 36 directs the damper 22 to open. If the monitored level of carbon dioxide is equal to the preset level of carbon dioxide, then the controller 36 does not change the position of the damper 22. If the monitored level of carbon dioxide is less than the preset level of carbon dioxide, then the controller 36 directs the damper 22 to close. In some embodiments multiple carbon dioxide level ranges are programmed into the controller 36. Depending on the carbon dioxide level range which is monitored, the controller 36 can direct the damper 22 to fully open or close, partially open or close, or maintain the current position.

An alternative embodiment of the illustrated invention functions as follows. The carbon dioxide sensor 34 monitors the level of carbon dioxide in the passenger compartment 12 and communicates the level of carbon dioxide to the controller 36. The door sensor 16 senses the occurrence and duration of a door opening event of a door 14 of the passenger vehicle 10 and communicates the occurrence and duration of the door opening event to the controller 36. The damper sensor 32 senses the status of damper opening event (for example percentage of opening if operated continuously, or the occurrence of the damper opening event and the duration of the damper opening event, if operated on/off) and communicates the occurrence, percentage open, and duration of the damper opening event to the controller 36. The controller 36 estimates the amount of fresh air that is introduced into the passenger compartment 12 by comparing the information received from the door sensor 16 and damper sensor 32 with a programmed table which gives the amount of fresh air that is introduced into the passenger compartment 12 by the door opening event and/or damper opening event. If the amount of fresh air that is introduced into the passenger vehicle 10 by the door opening events and/or damper opening events is sufficient to lower the level of carbon dioxide in the passenger compartment 12 to the preset level, then the controller 36 directs the damper 22 to close. If the amount of fresh air that is introduced into the passenger vehicle 10 by one or more door opening events and/or damper opening events is not sufficient to lower the level of carbon dioxide in the passenger compartment 12 to the preset level, then the controller 36 directs the damper 22 to open. In some embodiments the preset level of carbon dioxide is a range of carbon dioxide levels. In some embodiments, multiple carbon dioxide level ranges are programmed into the controller 36. Depending on the monitored carbon dioxide level, the controller 36 can direct the damper 22 to fully open or close, partially open or close, or maintain the current position.

In some embodiments the controller 36 estimates the occupancy of the passenger compartment 12 based on the level of carbon dioxide sensed by the carbon dioxide sensor 34 and a fresh airflow rate. The fresh airflow rate is calculated by estimating the amount of fresh air that is introduced into the passenger compartment 12 by the damper 22. The controller 36 is programmed with an approximate airflow rate for a range of positions of the damper 22 and the speed of the evaporator fan 30. In an alternate embodiment the fresh airflow rate is calculated by estimating the amount of fresh air that is introduced into the passenger compartment 12 by the damper 12, the evaporator fan 30, and the door 14. The controller is also programmed with an approximate airflow rate that occurs when the door 14 is in the open position. The occupancy is calculated by multiplying the fresh airflow rate (volume/time) by the difference between the concentration of carbon dioxide in the passenger compartment 12 and the outdoor concentration of carbon dioxide (mass/volume), and dividing the result by the average carbon dioxide production rate per person (mass/time*person). Symbolically, the formula is:

(fresh airflow rate*(CO2 concentration of passenger compartment−CO2 concentration of outdoor air))/CO2 production rate per person=passenger compartment occupancy

After the controller 36 calculates the occupancy of the passenger compartment 12, the controller 36 operates at least one of the compressor 26 and the evaporator fan 30 at a level corresponding to a preset level for the occupancy of the passenger compartment 12. In this embodiment, the damper 22 is not opened or closed based on the occupancy of the passenger compartment 12; instead, the damper 22 is opened or closed based on the level of carbon dioxide sensed by the carbon dioxide sensor 34 as described in the preceding paragraph. In an alternative embodiment, the controller 36 estimates the occupancy of the passenger compartment 12 based on level of carbon dioxide sensed by the carbon dioxide sensor 34, the rate of change of the level of the carbon dioxide sensed by the carbon dioxide sensor 34, and a fresh airflow rate.

In an alternative embodiment, the controller determines the occupancy of the passenger compartment 12 as described above. At the same time, the controller can apply a control algorithm to reduce the energy consumption of the air conditioning system 18. The controller 36 is able to move the damper 22 to vary the amount of fresh air that enters the passenger compartment 12 based on the occupancy of the passenger compartment 12. The controller 36 is also able to vary the speed of the evaporator fan 30 based on the occupancy of the passenger compartment 12. In addition, the controller 36 can vary the speed of the compressor 26 based on the occupancy of the passenger compartment 12. By varying how often the damper 22 opens, the speed of the evaporator fan 30, and the speed of the compressor 26, the passenger vehicle 10 air conditioning system 18 is able to operate more efficiently because the air conditioning system 18 only operates at a level needed for the occupancy of the passenger compartment 12. In an alternative embodiment a variable displacement compressor (not shown) is used in place of the compressor 26, and the controller 36 varies the displacement of the variable displacement compressor based on the occupancy of the passenger compartment 12.

The illustrated embodiments described above have employed a carbon dioxide sensor 34 to monitor the level of carbon dioxide in the passenger compartment 12. However, any of the embodiments illustrated above can use a volatile organic compound (VOC) sensor (not shown), a dust sensor (not shown), or some other sensor which measures contaminates produced by humans, in place of the carbon dioxide sensor 34. In addition, the carbon dioxide sensor 34 can be used in conjunction with at least one of a VOC sensor, a dust sensor, and some other sensor which measures contaminates produced by humans. One or more alternate or additional sensors communicate with the controller 36 and the controller 36 compares the level of sensed contaminate to a preset level of sensed contaminate. The controller 36 then operates as described in one of the embodiments above.

In one embodiment at least one of the carbon dioxide sensor 34, VOC sensor, dust sensor, and some other sensor which measures contaminates produced by humans, can be placed in the return air duct 28 of the passenger vehicle 10 air conditioning system 18. In another embodiment, at least one of the carbon dioxide sensor 34, VOC sensor, dust sensor, and some other sensor which measures contaminates produced by humans, can be placed in the passenger compartment 12 of the passenger vehicle 10.

Thus, the invention provides, among other things, a passenger vehicle air conditioning system. Various features and advantages of the invention are set forth in the following claims.

What is claimed is:

1. A passenger vehicle air conditioning system comprising:
a fresh air duct fluidly connecting ambient air of the environment outside of the passenger vehicle and a passenger compartment inside of the passenger vehicle;
a damper disposed in the fresh air duct and movable within the duct to vary the amount of ambient air allowed to enter the passenger compartment;
a contaminate sensor operable to monitor a level of contaminate indicative of the contaminate level within the passenger compartment of the passenger vehicle; and
a controller in communication with the contaminate sensor and the damper, wherein the controller moves the damper to vary the amount of fresh air that enters the passenger compartment based on the contaminate level sensed by the contaminate sensor

2. The passenger vehicle air conditioning system of claim 1, further comprising a return air duct fluidly connecting the passenger compartment with the fresh air duct, the return air duct receiving air from inside the passenger compartment upstream of the fresh air duct, wherein the contaminate sensor is disposed in the return air duct.

3. The passenger vehicle air conditioning system of claim 2, wherein the controller is programmed with a preset contaminate level, and moves the damper to vary the amount of fresh air that enters the passenger compartment based on the contaminate level sensed by the contaminate sensor relative to the preset contaminate level.

4. The passenger vehicle air conditioning system of claim 3, wherein the contaminate is carbon dioxide and the contaminate sensor is a carbon dioxide sensor.

5. The passenger vehicle air conditioning system of claim 1, wherein the controller estimates the occupancy of the passenger compartment based on the contaminate level sensed by the contaminate sensor and the fresh airflow rate, and wherein the controller moves the damper to vary the amount of fresh air that enters the passenger compartment based on the occupancy.

6. The passenger vehicle air conditioning system of claim 5, wherein the contaminate is carbon dioxide and the contaminate sensor is a carbon dioxide sensor.

7. The passenger vehicle air conditioning system of claim 5, further comprising a refrigerant circuit including an evaporator, an evaporator fan operable to move air through the evaporator, and a compressor for directing refrigerant to the evaporator, wherein the controller varies the speed of the evaporator fan and the speed of the compressor based on the occupancy.

8. The passenger vehicle air conditioning system of claim 5, wherein the controller moves the damper to near fully open position providing a first amount of fresh air that enters the passenger compartment that corresponds to a designed unit capacity based on the design occupancy, and wherein the controller moves the damper in the closing direction to a partially closed position providing a second amount of fresh air less than the first amount that enters the passenger compartment based on the occupancy estimated by the controller.

9. A passenger vehicle comprising:
a passenger compartment;
a fresh air duct fluidly connecting ambient air of the environment outside of the passenger vehicle and a passenger compartment inside of the passenger vehicle;
a damper disposed in the fresh air duct and movable within the duct to vary the amount of ambient air allowed to enter the passenger compartment;
a contaminate sensor operable to monitor a level of contaminate indicative of the contaminate level within the passenger compartment of the passenger vehicle; and
a controller in communication with the contaminate sensor and the damper, wherein the controller moves the damper to vary the amount of fresh air that enters the passenger compartment based on the contaminate level sensed by the contaminate sensor

10. The passenger vehicle of claim 9, further comprising a return air duct fluidly connecting the passenger compartment with the fresh air duct, the return air duct receiving air from inside the passenger compartment upstream of the fresh air duct, wherein the contaminate sensor is disposed in the return air duct.

11. The passenger of claim 10, wherein the controller is programmed with a preset contaminate level, and moves the damper to vary the amount of fresh air that enters the passenger compartment based on the contaminate level sensed by the contaminate sensor relative to the preset contaminate level.

12. The passenger vehicle of claim 11, wherein the contaminate is carbon dioxide and the contaminate sensor is a carbon dioxide sensor.

13. The passenger vehicle of claim 9, wherein the controller estimates the occupancy of the passenger compartment based on the contaminate level sensed by the contaminate sensor and the fresh airflow rate, and wherein the controller moves the damper to vary the amount of fresh air that enters the passenger compartment based on the occupancy.

14. The passenger vehicle of claim 13, wherein the contaminate is carbon dioxide and the contaminate sensor is a carbon dioxide sensor.

15. The passenger vehicle of claim 13, further comprising a refrigerant circuit including an evaporator, an evaporator fan operable to move air through the evaporator, and a compressor for directing refrigerant to the evaporator, wherein the controller varies the speed of the evaporator fan and the speed of the compressor based on the occupancy.

16. The passenger vehicle of claim 13, wherein the controller moves the damper to near fully open position providing a first amount of fresh air that enters the passenger compartment that corresponds to a designed unit capacity based on the design occupancy, and wherein the controller moves the damper in the closing direction to a partially closed position providing a second amount of fresh air less than the first amount that enters the passenger compartment based on the occupancy estimated by the controller.

17. A method of operating an air conditioning system of a passenger vehicle, the method comprising:
fluidly connecting with a fresh air duct of the air conditioning system ambient air of the environment outside of the passenger vehicle and a passenger compartment inside of the passenger vehicle;
providing a damper disposed in the fresh air duct;
monitoring a contaminate level of within a passenger compartment of the passenger vehicle;
moving the damper to vary the amount of fresh air that enters the passenger compartment based on the contaminate level.

18. The method of claim 17, further comprising moving the damper to vary the amount of fresh air that enters the passenger compartment based on the contaminate level relative to a preset contaminate level.

19. The method of claim 17, further comprising estimating the occupancy of the passenger compartment based on the contaminate level; and
moving the damper to vary the amount of fresh air that enters the passenger compartment based on the occupancy.

20. The method of claim 19, further comprising estimating the occupancy of the passenger compartment based level of carbon dioxide and the fresh airflow rate.

21. The method of claim 20, further comprising varying the speed of an evaporator fan of the refrigeration system and the speed of a compressor of the refrigeration system based on the occupancy.

22. The method of claim 21, further comprising moving the damper to near a fully open position providing a first amount of fresh air that enters the passenger compartment that corresponds to a designed unit capacity based on the design occupancy; and
moving the damper in the closing direction to a partially closed position providing a second amount of fresh air less than the first amount that enters the passenger compartment.

23. The method of claim 17, wherein the contaminate is carbon dioxide.
